(19) United States
(12) Patent Application Publication
(10) Pub. No.: US 2026/0301491 A1
(43) Pub. Date: Oct. 1, 2026

(54) CONTROLLING ACCESS TO A RESTRICTED PHYSICAL SPACE

(71) Applicant: ABLOY OY, Joensuu (FI)

(72) Inventor: Marko Ovaska, Helsinki (FI)

(21) Appl. No.: 19/477,842

(22) PCT Filed: Apr. 25, 2024
(86) PCT No.: PCT/EP2024/061427

§ 371 Date: Oct. 23, 2025

(30) Foreign Application Priority Data
Apr. 27, 2023 (SE) 2350506-8

(51) Int. Cl. G07C 9/00

(52) U.S. Cl. CPC G07C 9/00309; G07C 9/00896; G07C 2009/00317; G07C 2009/00769; G07C 2009/0092; G07C 2209/63

(57) ABSTRACT

It is provided a system (1) comprising: an electronic lock (12) for controlling access to a restricted physical space (16), a first location source (2); a second location source (13). The electronic lock (12) is configured to: receive an access request from a requesting entity (2); obtain a first location indication; obtain a second location indication; obtain a set of at least one limited geographic area; determine that a first condition is true, that the first location indication points to a location within a limited geographic area of the set; determine that a second condition is true, that the second location indication points to a location within the same limited geographic area; determine that a third condition is true that authorisation is granted based on the access request; and set the electronic lock (12) in an unlocked state.

### TECHNICAL FIELD

The present disclosure relates to the field of controlling access to a restricted physical space and in particular to controlling access to a restricted physical space based on a first location indication and a second location indication.

### BACKGROUND

Locks and keys are evolving from the traditional pure mechanical locks. These days, electronic locks are becoming increasingly common. For electronic locks, no mechanical key profile is needed for authentication of a user. The electronic locks can e.g. be opened using an electronic key stored on a special carrier (fob, card, etc.) or in a smartphone. The electronic key and electronic lock can e.g. communicate over a wireless interface. Such electronic locks provide a number of benefits, including improved flexibility in management of access rights, audit trails, key management, etc.

In some cases, access control can be conditioned also on location, e.g. that a lock of a shipping container should only be unlockable when being located within a certain pre-defined geographic area.

However, in some circumstances, an attacker can spoof the location to thereby circumvent the location condition of access control.

### SUMMARY

One object is to reduce the ability of an attacker to circumvent location-based access control.

According to a first aspect, it is provided a system comprising: an electronic lock for controlling access to a restricted physical space; a first location source; a second location source. The electronic lock comprises: a processor; and a memory storing instructions that, when executed by the processor, cause the electronic lock to: receive an access request from a requesting entity; obtain, over local communication, a first location indication, indicating a location of the first location source; obtain, over local communication, a second location indication, indicating a location of the second location source being distinct from the first location source; obtain a set of at least one limited geographic area; determine that a first condition is true, wherein the first condition is that the first location indication points to a location within a limited geographic area of the set; determine that a second condition is true, wherein the second condition is that the second location indication points to a location within the same limited geographic area of the set as the first location indication; determine that a third condition is true, wherein the third condition is that authorisation is granted based on the access request; and set the electronic lock in an unlocked state.

The first location source may be an electronic key, and the second location source is a communication gateway.

According to a second aspect, it is provided a method for controlling access to a restricted physical space. The method is performed by an electronic lock. The method comprises: receiving an access request from a requesting entity; obtaining, over local communication, a first location indication, indicating a location of a first location source; obtaining, over local communication, a second location indication, indicating a location of a second location source being distinct from the first location source; obtaining a set of at least one limited geographic area; determining that a first condition is true, wherein the first condition is that the first location indication points to a location within a limited geographic area of the set; determining that a second condition is true, wherein the second condition is that the second location indication points to a location within the same limited geographic area of the set as the first location indication; determining that a third condition is true, wherein the third condition is that authorisation is granted based on the access request; and setting the electronic lock in an unlocked state.

The local communication may be based on short-range wireless communication.

The short-range wireless communication may be based on at least one of Bluetooth, Bluetooth low energy, near-field communication NFC, and radio frequency identification RFID.

The determining that a third condition is true may comprise determining that authorisation is granted based only on the access request and locally stored data.

The first location source may be a communication gateway.

The second location source may be an electronic key.

The obtaining the set of at least one limited geographic area may comprise obtaining the set based on the access request.

Each one of the limited geographic areas may be defined in the access request.

The first location source and the second location source may be based on different localisation technologies.

According to a third aspect, it is provided, it is provided an electronic lock for controlling access to a restricted physical space. The electronic lock comprises: a processor; and a memory storing instructions that, when executed by the processor, cause the electronic lock to: receive an access request from a requesting entity; obtain, over local communication, a first location indication, indicating a location of a first location source; obtain, over local communication, a second location indication, indicating a location of a second location source being distinct from the first location source; obtain a set of at least one limited geographic area; determine that a first condition is true, wherein the first condition is that the first location indication points to a location within a limited geographic area of the set; determine that a second condition is true, wherein the second condition is that the second location indication points to a location within the same limited geographic area of the set as the first location indication; determine that a third condition is true, wherein the third condition is that authorisation is granted based on the access request; and set the electronic lock in an unlocked state.

According to a fourth aspect, it is provided a computer program for controlling access to a restricted physical space. The computer program comprises computer program code which, when executed on an electronic lock causes the electronic lock to: receive an access request from a requesting entity; obtain, over local communication, a first location indication, indicating a location of a first location source; obtain, over local communication, a second location indication, indicating a location of a second location source; obtain a set of at least one limited geographic area; determine that a first condition is true, wherein the first condition is that the first location indication points to a location within a limited geographic area of the set; determine that a second condition is true, wherein the second condition is that the second location indication points to a location within the same limited geographic area of the set as the first location indication; determine that a third condition is true, wherein the third condition is that authorisation is granted based on the access request; and set the electronic lock in an unlocked state.

According to a fifth aspect, it is provided a computer program product comprising a computer program according to the fourth aspect and a computer readable means comprising non-transitory memory in which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 is a schematic diagram illustrating an environment in which embodiments presented herein can be applied;

FIG. 2 is a schematic diagram illustrating a system that can be applied in the environment of FIG. 1;

FIG. 3 is a schematic diagram illustrating geographic areas used for controlling access to the electronic lock;

FIG. 4 is a flow chart illustrating embodiments of methods for controlling access to a restricted physical space;

FIG. 5 is a schematic diagram illustrating components of the predicted entry position of FIG. 1; and

FIG. 6 shows one example of a computer program product comprising computer readable means.

### DETAILED DESCRIPTION

The aspects of the present disclosure will now be described more fully hereinafter with reference to the accompanying drawings, in which certain embodiments of the invention are shown. These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

Embodiments presented herein provide improved security for (moveable) electronic locks. Specifically, the electronic lock has a geofence condition that needs to be fulfilled for unlocking, based on two separate location sources that are local to the electronic lock. Moreover, authentication is applied as an additional condition. Only when all conditions are true is the electronic lock unlocked. The geofence condition prevents someone from unlocking the electronic lock when the electronic lock is in transit between two valid geographic areas. By using two separate location sources, an attacker is significantly less likely to be able to fool the system into considering the electronic lock to be in a valid geographic area when it is not, compared to relying on a single location source.

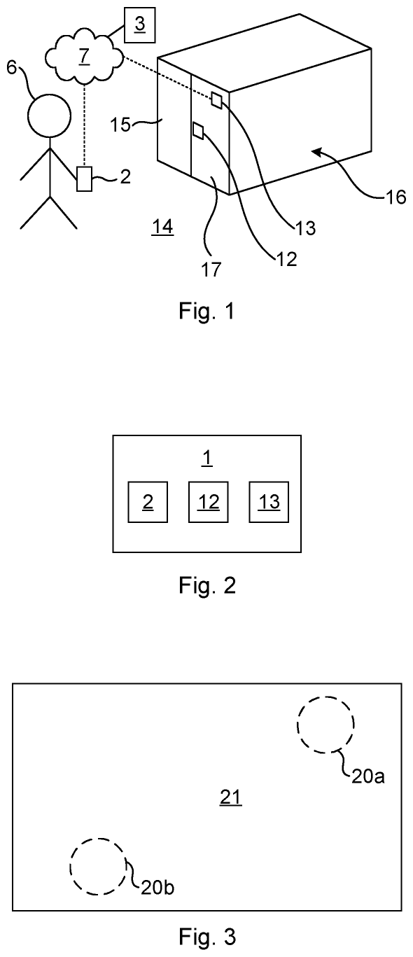

FIG. 1 is a schematic diagram illustrating an environment in which embodiments presented herein can be applied. Access to a physical space 16 is restricted by an openable physical barrier 15 which is selectively unlockable. The physical barrier 15 stands between the restricted physical space 16 and an accessible physical space 14. Note that the accessible physical space 14 can be a restricted physical space in itself, but in relation to this physical barrier 15, the accessible physical space 14 is accessible. The barrier 15 can be a door, gate, hatch, cabinet door, drawer, window, etc. An electronic lock 12 is provided in order to control access to the physical space 16, by selectively unlocking the barrier 15. In the example illustrated in FIG. 1, the restricted physical space 16 is the interior space of a shipping container. However, it is to be noted that the restricted physical space 16 can be any suitable physical space for which access can be controlled using a moveable electronic lock 12.

The electronic lock 12 can be provided in a structure 17 (such as a side wall or crossbar) securing the barrier 15, or the electronic lock 12 can be provided in the barrier 15 itself. The electronic lock 12 is controllable to be in a locked state or in an unlocked state.

A user 6 carries an electronic key 2. The electronic key 2 can be in any suitable format that allows an access control device to communicate (wirelessly or conductively) with the electronic lock 12 to evaluate whether to grant access. For instance, the electronic key 2 can be in the form of a key fob, a key card, a hybrid mechanical/electronic key or embedded in a smartphone. Depending on the access rights for the electronic key 2, it can be used in the process of unlocking the electronic lock 12. It is to be noted that the functionality mentioned for the electronic key 2 can also optionally be provided using a communication gateway 13. The communication gateway 13 allows the electronic lock 12 to communicate with a server 3. The communication gateway 13 can also communicate over local communication with the electronic lock 12. This allows the server 3 to remotely control the locking/unlocking state of the electronic lock 12.

The gateway device 13 can be battery-powered or mains-powered, and is provided in the vicinity of the electronic lock 12. For instance, the gateway device 13 can be provided in a secure location. The secure location can e.g. be within a shipping container, in which case antennas for the gateway device 13 can be provided external to the container casing, of the shipping contained secured by the electronic lock 12. Alternatively, the secure location can be a fixed location within a warehouse. The gateway device 13 communicates with the electronic lock 12 over local communication. The gateway device 13 can communicate with the server 3 via a network 7, e.g. based on Wi-Fi, and/or a cellular network, complying with any one or a combination of sixth generation (6G) mobile networks, next generation mobile networks (fifth generation, 5G), LTE (Long Term Evolution), UMTS (Universal Mobile Telecommunications System) utilising W-CDMA (Wideband Code Division Multiplex). When the gateway device 13 is battery-powered, the communication between the gateway device 13 and the network 7 can be based on a low-power cellular interface, such as LTE M (LTE machine type communication) or NBIOT (narrowband internet-of-things), to conserver power in the battery.

The gateway device 13 functions as a location source for the electronic lock 12, e.g. based on an integrated localisation signal receiver. The localisation signal receiver can e.g. be based on GPS (Global Positioning System), Galileo, or any other satellite-based localisation. Alternatively or additionally, the location source of the gateway device 13 is based on cellular network location determination.

Local communication is to be construed as communication within the same site, e.g. within 100 metres, or withing communication range of the short-range wireless communication interface. For instance, the short-range wireless communication can be based on any one or more of Bluetooth, Bluetooth low energy (BLE), near-field communication (NFC), and radio frequency identification (RFID). Local Wi-Fi can also be used for local communication.

Optionally, the server 3 can communicate with the electronic lock 12, e.g. via the key 2 and/or the communication gateway 13. The communication between the server 3 and the electronic key 2 or communication gateway 13 can occur over a network 7, which can be an internet protocol (IP)-based network. The network 7 can e.g. comprise any one or more of a local wireless network, a cellular network, a wired local-area network, a wide-area network (such as the Internet), etc. The server 3 can e.g. support remote unlocking from a server application or from another user device.

As described in more detail below, as part of the access control process, the electronic lock 12 evaluates whether an entity (e.g. the electronic key 2 or the server 3) is authorised to unlock the electronic lock 12 based on an access request and location data. If the evaluation is successful, the electronic lock 12 is set in an unlocked state.

FIG. 2 is a schematic diagram illustrating a system 1 that can be applied in the environment of FIG. 1. The system 1 comprises the electronic lock 12, the communication gateway 13 and the electronic key 2. In this embodiment, the electronic key 2 is the first location source and the gateway device 13 is the second location source, or vice versa, for the electronic lock 12.

FIG. 3 is a schematic diagram illustrating geographic areas used for controlling access to the electronic lock 12.

A set is formed that includes all applicable geographic areas 20a-b. In this example, there is a first geographic area 20a and a second geographic area 20b that are included in the set. Each geographic area 20a, can be defined in any suitable way, e.g. using coordinates of a polygon encompassing the geographic area. Alternatively, each geographic area is defined by a shape (e.g. circle, oval, square, rectangle, etc.) that is predefined or explicitly defined per geographic area, as well as a reference coordinate (e.g. of a centre point or one corner of the shape) and a predefined or explicitly defined size parameter. External areas 21 are defined as any area outside the defined geographic areas 20a-b. As an example, the first geographic area 20a can be a first logistics centre in a first city and the second geographic area 20b can be a second logistics centre in a second city.

According to embodiments presented herein, it is a necessary condition that at least two location sources, that are local to the electronic lock 12, indicate a position within one (and the same) of the predefined geographic areas 20a, 20b.

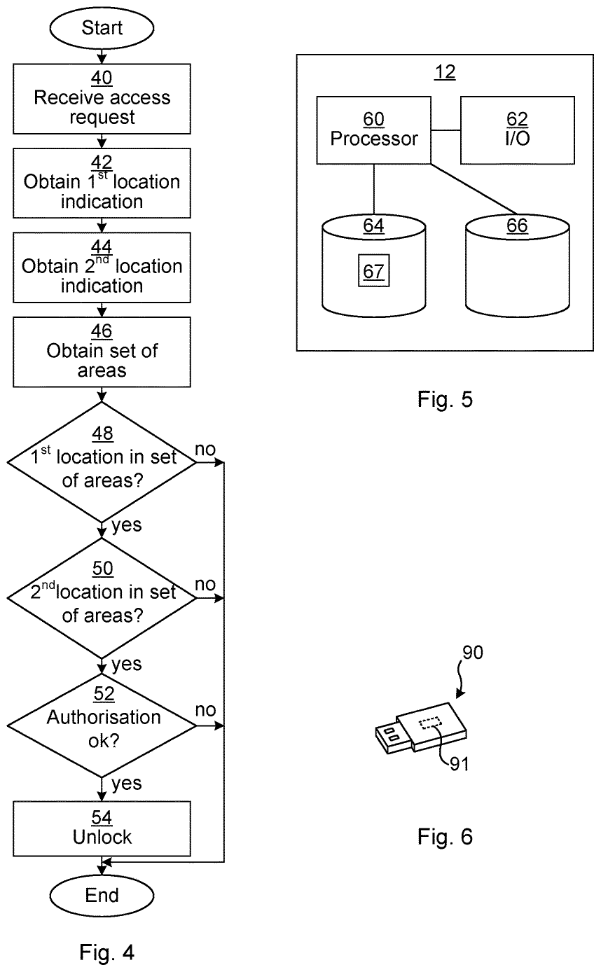

FIG. 4 is a flow chart illustrating embodiments of methods for controlling access to a restricted physical space, performed by an electronic lock 12.

In a receive access request step 40, the electronic lock 12 receives an access request 30 from a requesting entity 2, 3. The requesting entity can e.g. be an electronic key 2. Alternatively, the requesting entity can be a remote server 3, transmitting the access request via the gateway 13 to the electronic lock 12. As explained in more detail below, the access request can contain a set of geographic areas in which the electronic lock 12 must be located for access to be granted. The access request can be in the form of a delegation of a right to unlock the lock.

In an obtain 1^{st} location indication step 42, the electronic lock 12 obtains a first location indication, indicating a location of a first location source. The electronic lock 12 obtains the first location indication over local communication. For instance, the first location source can be a communication gateway 13. The first location indication can be received from the first location source. Since the first location indication is received over local communication, the first location indication is indicative of a location of the electronic lock 12, at least within the range of the local communication.

In an obtain 2^{nd} location indication step 44, the electronic lock 12 obtains a second location indication, indicating a location of a second location source. The second location source is distinct from the first location source. Also the second location indication is obtained over local communication. The second location indication can be received from the second location source. The first and second location sources can be of the same type or of different types. For instance, the first source location source can be a communication gateway 13 and the second location source can be the electronic key 2 (e.g. embodied in a smartphone), or vice versa. Alternatively, both the first and second location sources can be different instances of communication gateways 13, or both the first and second location sources can be different instances of electronic keys 2 (e.g. embodied in respective smartphones). Since the second location indication is received over local communication, the second location indication is also indicative of a location of the electronic lock 12, at least within the range of the local communication.

Optionally, the first location indication and/or the second location indication is cryptographically protected. This can be achieved with symmetric or asymmetric cryptography technologies, such as public key infrastructure (PKI). For instance, when PKI is applied, the location indication(s) can be cryptographically signed using a secret key that can be validated by the electronic lock using a public key that corresponds to the secret key.

The local communication can be internal communication within the electronic lock 12 if a location source is available within the electronic lock 12. Alternatively, the local communication can be based on short-range wireless communication, based on at least one of Bluetooth, BLE, NFC, and RFID. In one embodiment, the range of the local communication is at most tens of meters. This implies that the margin of error of the first and second location indications, since these are provided over local communication, is at most tens of metres. The second location source can be an electronic key 2. When the electronic key 2 is in the form of a smartphone, the location can be determined e.g. based on satellite-based localisation and/or cellular network-based localisation.

In one embodiment, the first location source and the second location source are based on different localisation technologies. For instance, the first location source can be based on a GPS receiver and the second location source can be based on cellular network localisation. By using different location technologies, it is even more difficult for an attacker to fool the system into considering the electronic lock to be in a valid geographic area when it is not.

In an obtain set of areas step 46, the electronic lock 12 obtains a set of at least one limited geographic area. The set can be prestored within the electronic lock 12. Alternatively, the set is comprised in the access request. In this case, the set can be cryptographically protected (e.g. by cryptographic signature or encryption, based on PKI) by a party trusted by the electronic lock 12. The identity of the party can e.g. be verified using a public key of the party stored in the electronic lock 12. This party can e.g. be the server 3. Hence, each one of the limited geographic areas can be defined in the access request, e.g. as described above with reference to FIG. 3. In other words, the access request can contain geographic area data that defines the geographic areas against which location is to be checked (see below).

In a conditional 1^{st} location in set of areas step 48, the electronic lock 12 determines whether a first condition is true. The first condition is that the first location indication points to a location within a limited geographic area of the set. The evaluation of the first condition is optionally based on a margin of error of the first location indication. The margin of error can be based on the accuracy of the localisation technology used and the range of the local communication, such that a more accurate localisation technology results in a smaller margin of error and the smaller the range of the local communication is, the smaller the margin of error is. If the first condition is true, the method continues to a conditional 2^{nd} location in the same area step 50. Otherwise, the method ends.

In the conditional 2^{nd} location in same area step 50, the electronic lock 12 determines whether a second condition is true. The second condition is that the second location indication points to a location within the same limited geographic area of the set as the first location indication. In other words, the second condition implies not only that the second location source is within one of the geographic areas of the set, but also that the second location source is within the same geographic area as the first location source. A margin of error can be applied in analogy with the description of the conditional 1^{st} location in set of areas step 48 above. If the second condition is true, the method continues to a conditional authorisation ok step 52. Otherwise, the method ends.

The conditional 1^{st} location in set of areas step 48 and the conditional 2^{nd} location in same area step 50 collectively implement a geofence verification. Since the electronic lock 12 is in local communication with the location sources, the electronic lock 12 is in the same general location as the location sources.

In the conditional authorisation ok step 52, the electronic lock 12 determines whether a third condition is true. The third condition is that authorisation is granted based on the access request. This determination can be based only on the access request and locally stored data, in which case the electronic lock 12 does not need ability to communicate with any external device for the authorisation. The authorisation can be checked by verifying that the access request is at least partly cryptographically signed by a party that the electronic lock 12 trusts, for which the electronic lock 12 has a prestored public key. The access request can be in the form of a delegation of a right of the requesting entity to unlock the lock. If the third condition is true, the method continues to an unlock step 54. Otherwise, the method ends.

It is to be noted that the conditional steps 48, 50, 52 can be applied in any order as long as all three conditions are found to be true prior to proceeding to the unlock step 54.

In the unlock step 54, the electronic lock 12 sets the electronic lock 12 in an unlocked state.

According to embodiments presented herein, only when all conditions are true is the electronic lock unlocked. The geofence conditions prevents someone from unlocking the electronic lock when the electronic lock is in transit between two valid geographic areas. By using two separate location sources, an attacker is significantly less likely to be able to fool the system into considering the electronic lock to be in a valid geographic area when it is not.

FIG. 5 is a schematic diagram illustrating components of the predicted entry position 12 of FIG. 1. A processor 60 is provided using any combination of one or more of a suitable central processing unit (CPU), graphics processing unit (GPU), multiprocessor, neural processing unit (NPU), microcontroller, digital signal processor (DSP), etc., capable of executing software instructions 67 stored in a memory 64, which can thus be a computer program product. The processor 60 could alternatively be implemented using an application specific integrated circuit (ASIC), field programmable gate array (FPGA), etc. The processor 60 can be configured to execute the method described with reference to FIG. 4 above.

The memory 64 can be any combination of random-access memory (RAM) and/or read-only memory (ROM). The memory 64 also comprises non-transitory persistent storage, which, for example, can be any single one or combination of magnetic memory, optical memory, solid-state memory or even remotely mounted memory.

A data memory 66 is also provided for reading and/or storing data during execution of software instructions in the processor 60. The data memory 66 can be any combination of RAM and/or ROM.

An I/O interface 62 is provided for communicating with external and/or internal entities using wired communication, e.g. based on Ethernet, and/or wireless communication, e.g. Bluetooth, BLE, Wi-Fi, and/or a cellular network, complying with any one or a combination of 6G mobile networks, 5G mobile networks, LTE, UMTS utilising W-CDMA, or any other current or future wireless network.

Other components of the electronic lock 12 are omitted in order not to obscure the concepts presented herein.

FIG. 6 shows one example of a computer program product 90 comprising computer readable means. On this computer readable means, a computer program 91 can be stored in a non-transitory memory. The computer program can cause a processor to execute a method according to embodiments described herein. In this example, the computer program product 90 is in the form of a removable solid-state memory, e.g. a Universal Serial Bus (USB) drive. As explained above, the computer program product could also be embodied in a memory of a device, such as the computer program product 64 of FIG. 5. While the computer program 91 is here schematically shown as a section of the removable solid-state memory, the computer program can be stored in any way which is suitable for the computer program product, such as another type of removable solid-state memory, or an optical disc, such as a CD (compact disc), a DVD (digital versatile disc) or a Blu-Ray disc.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims. Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A system comprising:
an electronic lock for controlling access to a restricted physical space;
a first location source; and
a second location source;
wherein the electronic lock comprises:
a processor; and
a memory storing instructions that, when executed by the processor, cause the electronic lock to:
receive an access request from a requesting entity;
obtain, over local communication, a first location indication, indicating a location of the first location source;
obtain, over local communication, a second location indication, indicating a location of the second location source being distinct from the first location source;
obtain a set of at least one limited geographic area;
determine that a first condition is true, wherein the first condition is that the first location indication points to a location within a limited geographic area of the set;
determine that a second condition is true, wherein the second condition is that the second location indication points to a location within the same limited geographic area of the set as the first location indication;
determine that a third condition is true, wherein the third condition is that authorisation is granted based on the access request; and
set the electronic lock in an unlocked state.

2. The system according to claim 1, wherein the first location source is an electronic key, and the second location source is a communication gateway.

3. A method for controlling access to a restricted physical space, the method being performed by an electronic lock, the method comprising:
receiving an access request from a requesting entity;
obtaining, over local communication, a first location indication, indicating a location of a first location source;
obtaining, over local communication, a second location indication, indicating a location of a second location source being distinct from the first location source;
obtaining a set of at least one limited geographic area;
determining that a first condition is true, wherein the first condition is that the first location indication points to a location within a limited geographic area of the set;
determining that a second condition is true, wherein the second condition is that the second location indication points to a location within the same limited geographic area of the set as the first location indication;
determining that a third condition is true, wherein the third condition is that authorisation is granted based on the access request; and
setting the electronic lock in an unlocked state.

4. The method according to claim 3, wherein the local communication is based on short-range wireless communication.

5. The method according to claim 4, wherein the short-range wireless communication is based on at least one of Bluetooth, Bluetooth low energy, near-field communication NFC, and radio frequency identification RFID.

6. The method according to claim 3, wherein the determining that the third condition is true comprises determining that authorisation is granted based only on the access request and locally stored data.

7. The method according to claim 3, wherein the first location source is a communication gateway.

8. The method according to claim 3, wherein the second location source is an electronic key.

9. The method according to claim 3, wherein the obtaining the set of at least one limited geographic area comprises obtaining the set based on the access request.

10. The method according to claim 9, wherein each one of the limited geographic areas are defined in the access request.

11. The method according to claim 3, wherein the first location source and the second location source are based on different localisation technologies.

12. An electronic lock for controlling access to a restricted physical space, the electronic lock comprising:
a processor; and
a memory storing instructions that, when executed by the processor, cause the electronic lock to:
receive an access request from a requesting entity;
obtain, over local communication, a first location indication, indicating a location of a first location source;
obtain, over local communication, a second location indication, indicating a location of a second location source being distinct from the first location source;
obtain a set of at least one limited geographic area;
determine that a first condition is true, wherein the first condition is that the first location indication points to a location within a limited geographic area of the set;
determine that a second condition is true, wherein the second condition is that the second location indication points to a location within the same limited geographic area of the set as the first location indication;
determine that a third condition is true, wherein the third condition is that authorisation is granted based on the access request; and
set the electronic lock in an unlocked state.

13. A non-transitory computer readable medium storing a computer program for controlling access to a restricted physical space, the computer program comprising computer program code which, when executed on an electronic lock, causes the electronic lock to:
receive an access request from a requesting entity;
obtain, over local communication, a first location indication, indicating a location of a first location source;
obtain, over local communication, a second location indication, indicating a location of a second location source;
obtain a set of at least one limited geographic area;
determine that a first condition is true, wherein the first condition is that the first location indication points to a location within a limited geographic area of the set;
determine that a second condition is true, wherein the second condition is that the second location indication points to a location within the same limited geographic area of the set as the first location indication;
determine that a third condition is true, wherein the third condition is that authorisation is granted based on the access request; and
set the electronic lock in an unlocked state.

14. (canceled)
